(19) United States
(12) Patent Application Publication
(10) Pub. No.: US 2023/0175145 A1
(43) Pub. Date: Jun. 8, 2023

(54) PHOTO ELECTROLYSIS DEVICE WITH PHOTOVOLTAIC DRIVEN HYDROGEN PUMP FOR HYDROGEN GENERATION AND WATER OXYGENATION

(71) Applicant: Ohmium International, Inc., Incline Village, NV (US)

(72) Inventor: Arne Ballantine, Incline Village, NV (US)

(21) Appl. No.: 18/075,138

(22) Filed: Dec. 5, 2022

Related U.S. Application Data
(60) Provisional application No. 63/286,840, filed on Dec. 7, 2021.

(51) Int. Cl. C25B 1/55; C25B 1/04; C25B 9/65; C25B 15/08; H01M 10/46; C02F 7/00; H01M 8/0656; A01K 63/04

(52) U.S. Cl. CPC C25B 1/55; C25B 1/04; C25B 9/65; C25B 15/08; H01M 10/465; C02F 7/00; H01M 8/0656; A01K 63/042; C02F 2103/20

(57) ABSTRACT

The present disclosure provides systems and methods for enhancing production of an aquaculture pond. The systems generally comprise a photo electrolysis array that includes an electrolyzer module and a photovoltaic cell. The electrolyzer module is operable to produce hydrogen and oxygen. A diffuser diffuses the produced oxygen into the aquaculture pond water, thereby increasing the concentration of oxygen in the aquaculture pond.

### CROSS-REFERENCE TO RELATED APPLICATION

This application claims benefit of U.S. Provisional Patent Application No. 63/286,840, which was filed in the U.S. Patent and Trademark Office on Dec. 7, 2021, the entire contents of which are incorporated herein by reference for all purposes.

### FIELD OF THE DISCLOSURE

The present disclosure relates to systems and methods for enhancing production of an aquaculture pond farm. The systems and methods relate to chemistry and chemical engineering.

### BACKGROUND OF THE INVENTION

Aquaculture pond farming has gained greater acceptance in recent years. Aquaculture pond farming has become a viable source commercially for many fish and crustacean species such as catfish and shrimp.

For aquaculture pond farming to become successful, numerous factors must be considered to ensure the production, health, and vitality of the aquaculture farm. Some of these factors include the appropriate fish and crustacean species to be raised, the necessary food for the fish and crustaceans, the appropriate water conditions to raise the specific species of the fish and crustaceans, the appropriate temperature of the aquaculture pond, the appropriate level of dissolved oxygen in the aquaculture pond, and the appropriate plant species in the aquaculture pond farm. Out of these numerous factors, the level of dissolved oxygen can be difficult to obtain and maintain. The level of dissolved oxygen in an aquaculture pond is dependent on a number of factors such as the level of nutrients in the aquaculture pond, the amount of water in the aquaculture pond, the temperature of the water in the aquaculture pond, the season of the year, the amount of algae and bacteria present in the aquaculture pond, the amount of organic matter suspended in the aquaculture pond, the species of fish and crustaceans, etc.

Presently, there are a number of systems which are used to increase the amount of dissolved oxygen in an aquaculture farm such as aerating the water with a paddlewheel aerators, addition of “fresh” water from a stream or a brook, low speed surface aerators, floating surface aerators, and fountains. Each of these systems are generally useful in increasing the level of dissolved oxygen in the aquaculture pond by mixing air with the aquaculture pond water with air. These systems for aerating the water can be quite complex and elaborate requiring additional infrastructure, plumbing connections, electrical connections, etc. Yet, the systems generally do not utilize renewable energy and provide only a modest increase in the level of dissolved oxygen.

What is needed are systems which improve production of an aquaculture pond farm by increasing level of dissolved oxygen in the aquaculture pond farm and that use renewable energy.

### SUMMARY OF THE INVENTION

Provided herein are systems for enhancing production of an aquaculture pond farm. The systems generally comprise a photo electrolysis array. The photo electrolysis array includes an electrolyzer module operable to produce hydrogen and oxygen, and a photovoltaic cell. The electrolyzer module is to be electrically connected to the photovoltaic cell, and the electrolyzer module is to be fluidly connected to a diffuser to diffuse the produced hydrogen into the aquaculture pond. In some embodiments, the photo electrolysis array is located in the aquaculture pond. In other embodiments, the photo electrolysis array is located adjacent to the aquaculture pond. In some embodiments, the system further comprises a hydrogen pump fluidly connected to the photo electrolysis array to pressurize the produced hydrogen. In additional embodiments, the photo electrolysis array comprises a plurality of photovoltaic cells.

In some embodiments, the system further comprises an input water pump fluidly connected to the photo electrolysis array to provide water to the photo electrolysis array. In some aspects, the photovoltaic cell is in electrical communication with the input water pump.

In some embodiments, the system further comprises an output water pump fluidly connected to the photo electrolysis array to distribute oxygenated water into the aquaculture pond. In some aspects, the photovoltaic cell is in electrical communication with the output water pump.

In some embodiments, the system further comprises an energy storage device electrically connected to the photo electrolysis array to store electricity.

In some embodiments, the system further comprises an oxygen storage device fluidly connected to the photo electrolysis array to store the produced oxygen. In some aspects, a first portion of the produced oxygen is diffused in the aquaculture pond and a second portion of the produced oxygen is stored in the oxygen storage device. In still further embodiments, the system further comprises an oxygen sensor operable to measure the concentration of oxygen in the aquaculture pond.

In some embodiments, the system further comprises a hydrogen load fluidly connected to the photo electrolysis array, wherein the hydrogen load is selected from the group consisting of a hydrogen storage system, a fuel cell, a combustion system, and any combination thereof.

In some embodiments, the system further comprises an auxiliary power source electrically connected to the photo electrolysis array to provide electricity to the photo electrolysis array.

Further provided herein are systems for enhancing production of an aquaculture pond farm. The system comprises a photo electrolysis array. The photo electrolysis array includes an electrolyzer module operable to produce hydrogen and oxygen, a photovoltaic cell, and a hydrogen pump fluidly connected to the electrolyzer module and operable to pressurize the produced hydrogen. The electrolyzer module is electrically connected to the photovoltaic cell, and the electrolyzer module fluidly connected to a diffuser to diffuse the produced hydrogen into the aquaculture pond.

Further provided herein are methods for enhancing production of an aquaculture pond farm. The methods generally comprise producing hydrogen and oxygen in a photo electrolysis array diffusing the produced oxygen into the aquaculture pond. The photo electrolysis array includes an electrolyzer module and a photovoltaic cell. In some embodiments, the methods further comprise circulating the oxygenated water through the aquaculture pond via an output water pump. In some additional embodiments, the methods further comprise storing excess electricity generated by the photovoltaic cell in an energy storage device. In further embodiments, the methods further comprise pressurizing the produced hydrogen for storage and use via a hydrogen pump. In still further embodiments, the methods further comprise detecting the oxygen concentration in the water of the aquaculture pond farm via an oxygen sensor.

Other features and iterations of the invention are described in more detail below.

### BRIEF DESCRIPTION OF THE FIGURES

FIG. 1 is a pictorial representation of an exemplary system for enhancing production in an aquaculture pond.

### DETAILED DESCRIPTION OF THE INVENTION

Described herein are systems for enhancing production of an aquaculture pond. This enhanced production relates to increasing and maintaining the level of oxygen in the aquaculture pond through a diffuser using renewable energy. The oxygen produced in a hydrogen electrolyzer is used to increase the oxygen concentration, rather than being released to the atmosphere. Additionally, the hydrogen produced in the system can be used for energy storage or other uses. Further, as will be appreciated by those having skill in the art, the presence of an oxygen-rich atmosphere around a photo electrolysis array that produces hydrogen gas has a high risk of explosion. Since the hydrogen and oxygen gases are separated and not released to the atmosphere, the risk of explosion is minimized. Thus, the systems of the present disclosure may further improve safety by removing oxygen from the system and incorporating the oxygen directly into an aquaculture pond.

As used herein, the terms “aquaculture pond” and “aquaculture pond farm” may be used interchangeably. An aquaculture pond may include a natural body of water or a man-made body of water. The aquaculture pond may include an open vessel (e.g., a tank), a closed vessel, or a reactor suitable for aquaculture. The aquaculture pond may contain saltwater or freshwater. Aquaculture ponds and methods of making or constructing aquaculture ponds are generally known in the art.

The aquaculture pond farm may be operable to raise aquaculture animals, aquaculture plants, aquaculture microorganisms, and combinations thereof. The aquaculture pond farm may be operable to raise a variety of aquaculture species and combinations thereof, including fish (e.g., carp, tilapia, salmon, milkfish, trout, bream, catfish, bass, yellowtail, pompano, etc.), crustaceans (e.g., shrimp, krill, crab, lobster, clams, oysters, mussels, etc.), algae (e.g., phytoplankton, purple laver, dulse, spirulina, chlorella, Irish moss, sea lettuce, dabberlocks, seaweed, etc.), and other species known to those having ordinary skill in the art. In a particular embodiment, the aquaculture pond farm of the present disclosure is operable to raise shrimp.

The system comprises a photo electrolysis array. The photo electrolysis array comprises an electrolyzer module. The electrolyzer module comprises an electrolyzer stack operable to convert water into gaseous oxygen and hydrogen. Electrolyzer stacks (also referred to as electrochemical stacks) and methods of making and procuring electrolyzer stacks are generally known in the art. In particular, electrolyzer modules suitable for use in the system of the present disclosure are described in U.S. application Ser. No. 17/101,232 (issued as U.S. Pat. No. 11,492,711) entitled “ELECTROCHEMICAL DEVICES, MODULES, AND SYSTEMS FOR HYDROGEN GENERATION AND METHODS OF OPERATING THEREOF”, the entire contents of which are incorporated by reference herein in their entirety. In some embodiments, the integrated system may comprise a plurality of photo electrolysis arrays.

The electrolyzer module may comprise a membrane electrolyte such as a proton exchange membrane (PEM). The PEM may comprise any suitable proton exchange (e.g., hydrogen ion transport) polymer membrane, such as Nafion® membrane composed of sulfonated tetrafluoroethylene based fluoropolymer-copolymer having a formula C₇HF₁₃O₅S·C₂F₄.

The electrolyzer module may further comprise power electronics. The power electronics may be formed or provided in a single assembly that connects input energy (e.g., from the photovoltaic cell), the electrolyzer stack, and/or additional energy outputs or energy loads. The power electronics may be operable to connect to DC energy inputs, AC energy inputs, and combinations thereof. The power electronics may further be operable to connect to DC energy loads, AC energy loads, and combinations thereof. The power electronics may comprise a GaN inverter board, an integrated power board, control cards, a display board, and/or a DAB converter, one or more transformers, one or more rectifiers, etc.

The photo electrolysis array comprises an inlet operable to receive water from a water source; for example, a water capture system (e.g., rainwater capture), tap water, a municipal water supply, and/or a natural body of water. The inlet may therefore be fluidly connected to the water source. In some embodiments, the water source may be the aquaculture pond itself. This is particularly preferred in embodiments where the photo electrolysis array is located in the aquaculture pond itself, thus reducing the total cost of the system and increasing overall efficiency.

The water from the water source may be pumped to the photo electrolysis array via an input water pump from the water source to the inlet of the photo electrolysis array. The water may be pumped at a sufficient pressure to be usable by the photo electrolysis array. The input water pump may be any pump known in the art suitable for pumping water, such as a centrifugal pump, a positive-displacement pump, or an axial-flow pump.

The photo electrolysis array comprises a first outlet operable to deliver oxygen to the aquaculture pond. Preferably, the first outlet is fluidly connected to a diffuser, which diffuses the oxygen into the aquaculture pond. The photo electrolysis array may generate oxygen at a rate of about 1 kg/hr or greater. For example, the oxygen may be generated at a rate of about 1 kg/hr or greater, about 10 kg/hr or greater, about 25 kg/hr greater, about 50 kg/hr or greater, or about 100 kg/hr or greater. Thus, the oxygen may be delivered to the diffuser and thus to the aquaculture pond at a rate of about 1 kg/hr or greater, about 10 kg/hr or greater, about 25 kg/hr greater, about 50 kg/hr or greater, or about 100 kg/hr or greater.

The diffuser may be operable to disperse the oxygen in the aquaculture pond such that the oxygen is dissolved in the aquaculture pond water. Devices for diffusing oxygen in water and methods of making and procuring the same are generally known in the art. The diffuser may comprise a microbubble diffuser, an atomizer, a sparser, coarse bubble aerators, fine bubble aerators, or other devices suitable for diffusing oxygen in water. The system may comprise a plurality of diffusers at multiple locations to more evenly distribute the oxygen in the aquaculture pond. After the diffuser diffuses oxygen into the water, the water may be referred to as oxygenated water.

The photo electrolysis array may further comprise an output water pump. The output water pump may be operable to circulate or otherwise distribute oxygenated water to the aquaculture pond farm. For example, after the diffuser diffuses oxygen into a portion of the aquaculture pond water, the oxygenated portion of the water may be pumped via the output water pump to more evenly distribute the oxygen throughout the aquaculture pond farm.

The photo electrolysis array may also comprise a second outlet operable to deliver hydrogen to a hydrogen load. The second outlet may be fluidly connected to the hydrogen load. Alternatively, the second outlet may be fluidly connected to a proton conducting hydrogen pump, which is fluidly connected to the hydrogen load. The hydrogen load may include a hydrogen storage system, a hydrogen fuel cell, a combustion system, and combinations thereof. Examples of these hydrogen loads are generally known in the art.

The hydrogen gas flowing from the photo electrolysis array through the second outlet preferably consists essentially of hydrogen and water. The hydrogen flowing from the photo electrolysis array may have a purity of about 90% to about 99%, or more preferably about 95% to about 99% by weight. For example, the purity of the hydrogen gas may be at least about 95%, at least about 96%, at least about 97%, at least about 98%, or at least about 99% on a weight basis. The impurities of the hydrogen gas flowing from the photo electrolysis array may include oxygen and water.

The photo electrolysis array further comprises a photovoltaic cell or a plurality of photovoltaic cells. The photovoltaic cell is preferably electrically connected to the electrolyzer module and provides electricity to the electrolyzer module such that the electrolyzer module may perform electrolysis. The photovoltaic cell may be mounted on a tracker to optimize production of electricity throughout the day. Photovoltaic cells and methods of making and procuring photovoltaic cells are generally known to those having ordinary skill in the art. Preferably, when the photo electrolysis array is located in the aquaculture pond, the photovoltaic cell is not submerged in the water, which may reduce the efficiency of electricity production.

The photo electrolysis array may be waterproof or water resistant when the photo electrolysis array is located in the aquaculture pond. Methods of making equipment and devices waterproof are generally known in the art.

The system may further comprise a proton conducting hydrogen pump. The proton conducting hydrogen pump (also referred to herein as a “hydrogen pump”) may be, for example, an electrochemical pump. As used in this context, an electrochemical pump shall be understood to include a proton exchange membrane (i.e., a PEM electrolyte) disposed between an anode and a cathode. The proton exchange membrane may be any proton exchange membrane discussed herein. The hydrogen pump may generate protons moveable from the anode through the proton exchange membrane to the cathode form pressurized hydrogen. Thus, the hydrogen pump may be operable to provide pressurized hydrogen produced by the electrolyzer module to a hydrogen load. The hydrogen pump may be fluidly connected to the photo electrolysis array and to a hydrogen load.

In particular, hydrogen pumps suitable for use in the system of the present disclosure are described in U.S. application Ser. No. 17/101,232 entitled “ELECTROCHEMICAL DEVICES, MODULES, AND SYSTEMS FOR HYDROGEN GENERATION AND METHODS OF OPERATING THEREOF”, filed Nov. 23, 2020, the entire contents of which are incorporated by reference herein in their entirety.

The hydrogen pump may be operable to improve the purity of the hydrogen. For example, the hydrogen flowing from the hydrogen pump may have a purity of about 98% to about 99.999%, such as from about 98% to about 99%, about 98% to about 99.9%, about 98% to about 99.99%, about 98% to about 99.999%, about 99% to about 99.999%, about 99.9% to about 99.999%, or about 99.99% to about 99.999%. The major impurities of the hydrogen flowing from the hydrogen pump may include oxygen and water.

The system may further comprise a dryer fluidly connected to the hydrogen pump and/or fluidly connected to the electrolyzer module. The dryer may be, for example, a pressure swing adsorption (PSA) system, a temperature swing adsorption (TSA) system, a hybrid PSA-TSA system, or a membrane purifier. The dryer may include one or more beds of a water-adsorbent material, such as activated carbon, silica, zeolite or alumina. The dryer may include a membrane such as a PEM electrolyte. The dryer may comprise an inlet portion and an outlet portion. The inlet portion is operable to receive hydrogen from the electrolyzer module. The inlet portion of the dryer may therefore be fluidly connected to the hydrogen pump. The inlet hydrogen gas may have a purity of about 95% to about 98%, wherein the major impurity is water. The outlet portion is operable to provide dry hydrogen to a hydrogen load, and therefore may be fluidly connected to a hydrogen load. The dryer may also comprise a second outlet comprising low pressure hydrogen, e.g., from about 1 bar to about 2 bar, or less than about 1 bar.

The dryer may further comprise a purge stream. The purge stream is operable to remove excess water vapor and other gases, including oxygen, from the hydrogen produced in the electrolyzer module. The purge stream may comprise hydrogen having a concentration from about 5% to about 25%, or more preferably less than 5%. The balance of the purge stream may comprise water and oxygen. The purge stream may be fluidly connected to the aquaculture pond or to the atmosphere.

The photo electrolysis array may be located in the aquaculture pond or adjacent to the aquaculture pond. For example, the photo electrolysis array may be in the pond water, on the shore adjacent to the pond, or a short distance from the aquaculture pond.

The hydrogen load may comprise a hydrogen storage system. Systems and methods for storing hydrogen are generally well-known in the art and include, for example, storage tanks and vessels. The hydrogen storage system may be located within the photo electrolysis array or separately from the photo electrolysis array. The hydrogen may be stored at a pressure from about 10 bar to about 800 bar; for example, about 10 bar, about 50 bar, about 100 bar, about 150 bar, about 200 bar, about 250 bar, about 300 bar, about 350 bar, 400 bar, 450 bar, 500 bar, 550 bar, 600 bar, 650 bar, about 700 bar, about 750 bar, or about 800 bar. The pressurized hydrogen may be stored at a pressure from about 10 bar to about 50 bar, about 10 bar to about 100 bar, about 10 bar to about 200 bar, about 10 bar to about 300 bar, about 10 bar to about 400 bar, about 10 bar to about 500 bar, about 10 bar to about 600 bar, about 10 bar to about 700 bar, about 10 bar to about 800 bar, about 100 bar to about 800 bar, about 200 bar to about 800 bar, about 300 bar to about 800 bar, about 400 bar to about 800 bar, about 500 bar to about 800 bar, about 600 bar to about 800 bar, about 700 bar to about 800 bar, about 300 bar to about 700 bar, or about 300 bar to about 600 bar. In some examples, the hydrogen may be stored at a pressure of about 350 bar, about 550 bar, or about 700 bar. One or more hydrogen pumps may be used to pressurize the hydrogen. Alternatively, other devices and systems to increase the pressure of hydrogen may be used, such as a compressor.

The hydrogen load may comprise a hydrogen fuel cell. The hydrogen fuel cell may be operable to produce electricity by combining hydrogen produced by the photo electrolysis array and oxygen from the air to form water. Hydrogen fuel cells and methods of making and procuring hydrogen fuel cells are generally well known in the art. Preferably, the hydrogen fuel cell is a proton-exchange membrane fuel cell.

The hydrogen fuel cell may be in electrical communication with the photo electrolysis array. The hydrogen fuel cell may also be in fluid communication with the photo electrolysis array and/or a hydrogen storage system. Preferably, the hydrogen fuel cell is in fluid communication with a hydrogen storage system and is operable to produce electricity at times when the photovoltaic cell is not producing electricity or is producing an insufficient amount of electricity.

The system further may further comprise an energy storage device. The energy storage device may provide electricity to the system during times when the photovoltaic cell cannot produce electricity or produces an insufficient amount of electricity (e.g., when the sun is not shining or during maintenance) to meet system requirements. The energy storage device may comprise any mechanism or apparatus operable to store and distribute electricity. For example, the energy storage device may include batteries (e.g., lead-acid batteries, lithium ion batteries, lithium iron batteries, etc.), compressed air, pumped hydroelectric, or other energy storage devices known in the art and combinations thereof. Preferably, the energy storage device includes batteries. The energy storage device may be electrically connected to the photo electrolysis array, and to any of the other system components described herein.

The system may further comprise an auxiliary power source. The auxiliary power source may be electrically connected to the photo electrolysis array and to any of the system components described herein. The auxiliary power source may be used to supplement the electricity provided by the photovoltaic cell to meet system requirements and/or to charge the energy storage device. The auxiliary power source may include a renewable energy source such as wind power, tidal power, wave power, geothermal power, hydroelectric power, and other renewable energy sources known in the art and combinations thereof. In a particular embodiment, the auxiliary power source may include a hydrogen fuel cell, as further described hereinabove. The auxiliary power source may alternatively or additionally comprise a power grid, such as a regional power grid, a municipal power grid, or a micro grid. Although less preferable, the auxiliary power source may comprise non-renewable sources such as coal and natural gas.

The photo electrolysis array may receive input energy (i.e., electricity) from an intermittent source such as solar power (i.e., through the photovoltaic cell), the energy storage device, the auxiliary power source, or a combination thereof. In order to condition the energy from the photovoltaic cell, the photovoltaic cell may be electrically connected to a DC/DC converter. The energy storage device and/or the auxiliary power source may also be electrically connected to the DC/DC converter. The DC/DC converter may be electrically connected to an input water pump and/or an outlet water pump to pump water to and from the aquaculture pond.

The system may further comprise at least one valve fluidly connected to the first outlet of the photo electrolysis array and the at least one diffuser. The at least one valve may be operable to direct the flow of oxygen to the diffuser and thus the aquaculture pond. Thus, the valve is operable to modify the flow rate of the oxygen to the aquaculture pond. The valve may be any valve known to those having ordinary skill in the art, such as solenoid valve, control valve, flow regulating valve, back pressure regulating valve, y-type valve, piston valve, pressure regulating valve, or a check valve.

The at least one valve may be electrically connected to a controller and/or to an oxygen sensor. The at least one valve may increase or decrease the flow rate of the oxygen to the aquaculture pond based on instructions received from the controller. This may be accomplished by opening or closing the valve in response to a signal received from the controller. The flow rate of oxygen may be modified according to a predetermined schedule, in response to the oxygen concentration in the aquaculture pond reaching a predetermined threshold concentration, or in response to a direct request from a client or customer.

The at least one valve may modify the flow rate of oxygen to the aquaculture pond such that the concentration of oxygen in the aquaculture pond is from about 1 mg/L to about 20 mg/L or greater. For example, the concentration of oxygen in the aquaculture pond may be from about 1 mg/L to about 5 mg/L, about 1 mg/L to about 10 mg/L, about 1 mg/L to about 15 mg/L, about 1 mg/L to about 20 mg/L, about 5 mg/L to about 10 mg/L, about 5 mg/L to about 15 mg/L, about 5 mg/L to about 20 mg/L, about 10 mg/L to about 20 mg/L, or about 15 mg/L to about 20 mg/L. In another example, the concentration of oxygen in the aquaculture pond may be about 1 mg/L, about 2 mg/L, about 3 mg/L, about 4 mg/L, about 5 mg/L, about 6 mg/L, about 7 mg/L, about 8 mg/L, about 9 mg/L, about 10 mg/L, about 11 mg/L, about 12 mg/L, about 13 mg/L, about 14 mg/L, about 15 mg/L, about 16 mg/L, about 17 mg/L, about 18 mg/L, about 19 mg/L, or about 20 mg/L. In another embodiment, the concentration of oxygen in the aquaculture pond may be from at least about 5 mg/L to about 8 mg/L, at least about 5 mg/L to about 10 mg/L, at least about 5 mg/L to about 15 mg/L, at least about 5 mg/L to about 20 mg/L. In another embodiment, the concentration of oxygen in the aquaculture pond may be from at least about 6.5 mg/L to about 8 mg/L, at least at least about 6.5 mg/L to about 10 mg/L, at least about 6.5 mg/L to about 15 mg/L, or at least about 6.5 mg/L to about 20 mg/L.

The valve may modify the flow rate of oxygen to the water supply such that the saturation of oxygen in the water supply is from about 20% to about 90%.

The system may increase the oxygen concentration of the aquaculture pond by about 10% to about 50%.

Preferably, the oxygen concentration in the aquaculture pond farm is at least 4.5 mg/m L. Those having ordinary skill in the art will appreciate that an optimal oxygen concentration for the aquaculture farm may be determined based on the aquaculture being raised (animal, plant, microorganism, etc.), the size of the aquaculture pond, the number of individual organisms being raised, etc.

The system may further comprise an oxygen storage device or an oxygen storage system. Devices and systems for storing oxygen are generally known in the art. The oxygen may be stored on a short term basis (minutes or hours) or a long term basis (days, weeks, months, or more). The oxygen storage device may be fluidly connected to the photo electrolysis array to receive the oxygen produced by the photo electrolysis array. The oxygen storage device may also be fluidly connected to a diffuser to diffuse the stored oxygen into the aquaculture pond.

The system may further comprise an oxygen sensor that may be electrically connected the controller and/or to the valve. The oxygen sensor is operable to determine the concentration of oxygen in the aquaculture pond. Oxygen sensors and methods of making and procuring oxygen sensors are generally well-known to those having ordinary skill in the art. Preferably, the oxygen sensor has a sensitivity of at least about 1 mg/L, at least about 0.5 mg/mL, at least about 0.1 mg/mL, or at least about 0.01 mg/m L.

The system may further comprise a controller. The controller may be electrically connected to one or more of the system components described hereinabove. The controller is operable to adjust various parameters of the system and the components of the system based on various inputs received, such as temperature, flow rate, pressure, current, etc. The controller may also be operable to turn one or more system components off and on.

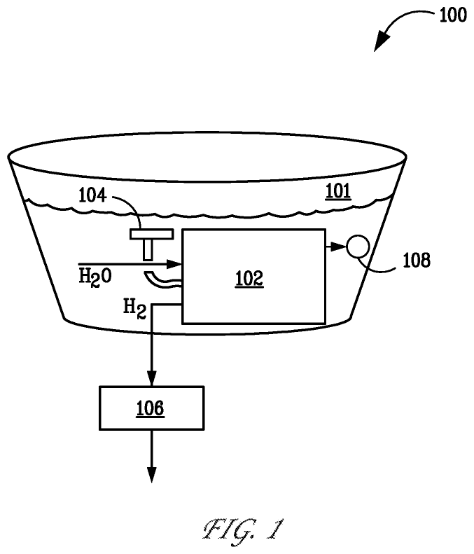

Referring now to FIG. 1, an embodiment of the system 100 of the present disclosure includes a photo electrolysis array 102 located in the aquaculture pond 101. The photo electrolysis array 102 comprises a photovoltaic cell and an electrolyzer module to produce hydrogen gas and oxygen gas. The photo electrolysis array 102 receives water from the aquaculture pond 101. The hydrogen gas produced in the electrolyzer module is supplied to a hydrogen storage system 106 for later use. The oxygen gas produced by the electrolyzer module is diffused into the aquaculture pond 101 via a diffuser 108. The diffused oxygen gas increases the oxygen concentration of the aquaculture pond 101, thereby improving the health stability of the aquaculture pond 101.

Further provided herein are methods for enhancing the production of an aquaculture pond farm. The methods generally utilize the systems described hereinabove to increase the oxygen concentration of the aquaculture pond farm. Generally, the method comprises producing hydrogen and oxygen in a photo electrolysis array and diffusing the produced oxygen into the aquaculture pond, thereby producing oxygenated water. The photo electrolysis array includes an electrolyzer module and a photovoltaic cell, or a plurality of photovoltaic cells, as described hereinabove.

The method may further comprise circulating the oxygenated water through the aquaculture pond via an output water pump. The output water pump may be any output water pump described herein. The output water pump may be operable to distribute the oxygenated water throughout the aquaculture pond.

The method may further comprise storing excess electricity generated by the photovoltaic panel in an energy storage device. The energy storage device may be any energy storage device described herein. The method may also include powering the photo electrolysis array using the energy stored in the energy storage device. This is particularly useful at times when the photovoltaic cell is not producing electricity or is producing an insufficient amount of electricity (e.g., when the sun is not shining).

The method may further comprise pressurizing the produced hydrogen via a hydrogen pump. The hydrogen pump may be any hydrogen pump described herein. The produced hydrogen may be pressurized for use, such as for use in a hydrogen fuel cell or a combustion system (e.g., a catalytic combustion reactor), or for storage in a hydrogen storage system.

The method may further comprise detecting the oxygen concentration in the water of the aquaculture pond farm via an oxygen sensor. The oxygen sensor may be any oxygen sensor described herein. In particular embodiments, the method may further include increasing or decreasing the flow rate of oxygen produced by the photo electrolysis array in response to the oxygen concentration detected by the oxygen sensor. The flow rate may increase or decrease by opening or closing a valve fluidly connected to the photo electrolysis array. The valve may open and close in response to an electrical communication received from a controller as described herein. For example, if the oxygen concentration reaches a predetermined maximum value, the valve may close to reduce the flow rate of oxygen entering the aquaculture pond. Alternatively, the valve may redirect a portion of the oxygen to an oxygen storage device or an oxygen load; therefore, the method may further comprise storing the produced oxygen in an oxygen storage device. As another example, if the oxygen concentration reaches a predetermined minimum value, the valve may open to increase the flow rate of oxygen entering the aquaculture pond.

### Definitions

As used herein, a “fluid” connection is a connection that allows for or facilitates the transfer of fluids including liquids and gases. Non-limiting examples of fluid connections include pipes, manifolds, ducts, valves, hoses, couplings, tubes, etc.

As used herein, an “electrical” connection is a connection that allows for or facilitates the transfer of electricity. Non-limiting examples of electrical connections include wires, cables, power lines, breakers, transformers, converters, rectifiers, switches, etc.

As used herein, an “operable” connection includes any connection that allows for or facilitates the operation of a system unit or process. An operable connection may include an electrical connection and/or a fluid connection.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or,” and the term “and” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as including any deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples or exemplary language (“e.g.,” “such as,” or the like) is intended merely to better illuminate the embodiments and does not pose a limitation on the scope of those embodiments. No language in the specification should be construed as indicating any unclaimed element as essential to the practice of the disclosed embodiments.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the scope of the disclosure.

What is claimed is:

1. A system for enhancing production of an aquaculture pond farm, the system comprising a photo electrolysis array, the photo electrolysis array including an electrolyzer module operable to produce hydrogen and oxygen and a photovoltaic cell, wherein:
the electrolyzer module is to be electrically connected to the photovoltaic cell, and
the electrolyzer module is to be fluidly connected to a diffuser to diffuse the produced oxygen into the aquaculture pond.

2. The system of claim 1, further comprising a hydrogen pump fluidly connected to the photo electrolysis array to pressurize the produced hydrogen.

3. The system of claim 1, further comprising an input water pump fluidly connected to the photo electrolysis array to provide water to the photo electrolysis array.

4. The system of claim 3, wherein the photovoltaic cell is in electrical communication with the input water pump.

5. The system of claim 1, further comprising an output water pump fluidly connected to the photo electrolysis array to distribute oxygenated water into the aquaculture pond.

6. The system of claim 5, wherein the photovoltaic cell is in electrical communication with the output water pump.

7. The system of claim 1, further comprising an energy storage device electrically connected to the photo electrolysis array to store electricity.

8. The system of claim 1, further comprising an oxygen storage device fluidly connected to the photo electrolysis array to store the produced oxygen.

9. The system of claim 8, wherein a first portion of the produced oxygen is diffused in the aquaculture pond and a second portion of the produced oxygen is stored in the oxygen storage device.

10. The system of claim 1, wherein the photo electrolysis array is located in the aquaculture pond.

11. The system of claim 1, wherein the photo electrolysis array is located adjacent to the aquaculture pond.

12. The system of claim 1, further comprising a hydrogen load fluidly connected to the photo electrolysis array, wherein the hydrogen load is selected from the group consisting of a hydrogen storage system, a fuel cell, a combustion system, and any combination thereof.

13. The system of claim 1, further comprising an auxiliary power source electrically connected to the photo electrolysis array to provide electricity to the photo electrolysis array.

14. The system of claim 1, further comprising an oxygen sensor operable to measure the concentration of oxygen in the aquaculture pond.

15. A system for enhancing production of an aquaculture pond farm, the system comprising a photo electrolysis array, the photo electrolysis array including:
an electrolyzer module operable to produce hydrogen and oxygen;
a photovoltaic cell; and
a hydrogen pump fluidly connected to the electrolyzer module and operable to pressurize the produced hydrogen,
wherein:
the electrolyzer module is electrically connected to the photovoltaic cell;
the electrolyzer module is fluidly connected to a diffuser to diffuse the produced oxygen in the aquaculture pond.

16. A method for enhancing production of an aquaculture pond farm, the method comprising:
producing hydrogen and oxygen in a photo electrolysis array, the photo electrolysis array including an electrolyzer module and a photovoltaic cell; and
diffusing the produced oxygen into the aquaculture pond.

17. The method of claim 15, further comprising circulating the oxygenated water through the aquaculture pond via an output water pump.

18. The method of claim 15, further comprising storing excess electricity generated by the photovoltaic cell in an energy storage device.

19. The method of claim 15, further comprising pressurizing the produced hydrogen for storage and use via a hydrogen pump.

20. The method of claim 15, further comprising detecting the oxygen concentration in the water of the aquaculture pond farm via an oxygen sensor.
